(19) United States
(12) Patent Application Publication
(10) Pub. No.: US 2012/0231737 A1
(43) Pub. Date: Sep. 13, 2012

(54) ENERGY DISTRIBUTION AMONG ANTENNAS IN AN ANTENNA SYSTEM

(75) Inventors: Lorenzo A. Ponce De Leon, Lake Worth, FL (US); Naveed Mirza, Boynton Beach, FL (US); Paul Morningstar, North Lauderdale, FL (US)

(73) Assignee: MOTOROLA, INC., Schaumburg, IL (US)

(21) Appl. No.: 11/686,461

(22) Filed: Mar. 15, 2007

Related U.S. Application Data
(60) Provisional application No. 60/867,994, filed on Nov. 30, 2006.

(51) Int. Cl. H04B 7/24

(52) U.S. Cl. 455/41.2

(57) ABSTRACT

A method (300, 400) for communicating RF signals from a mobile station (100). The method can include detecting whether the mobile station or a first antenna (105) of the mobile station is proximate to an object. Responsive to detecting that the mobile station or the antenna is proximate to the object, RF energy being communicated by the mobile station can be distributed among the first antenna and at least a second antenna (110). Distributing the RF energy can include equally distributing the RF energy among the first antenna, the second antenna and/or any additional antennas. Distributing the RF energy also can include unequally distributing the RF energy among the first antenna, the second antenna and/or any additional antennas.

### CROSS REFERENCES TO RELATED APPLICATIONS

This application claims benefit of U.S. provisional patent application Ser. No. 60/867,994, filed Nov. 30, 2006, which is herein incorporated by reference.

### BACKGROUND OF THE INVENTION

1. Field of the Invention

The present invention generally relates to communication devices and, more particularly, to mobile stations which include a plurality of antennas.

2. Background of the Invention

A mobile station typically communicates by establishing an RF communication link with a node of a communications network. For example, a mobile station may establish an RF communication link with a base station or a repeater of a cellular communications network. To support the RF communication link, a mobile station generally includes one or more transceivers and one or more antennas.

For a variety of reasons, mobile stations usually transmit at relatively low power, typically within the milliwatt range. Moreover, the signal strength of received signals also is fairly low. Thus, the efficiency with which a mobile station transmits and receives RF signals is a critical factor affecting mobile station performance. When the efficiency is adversely affected, for instance by improper positioning of an object such as a finger next to the mobile station's antenna, a call session can be interrupted or dropped, which is undesirable.

### SUMMARY OF THE INVENTION

The present invention relates to a method for communicating RF signals from a mobile station. The method can include detecting whether the mobile station or a first antenna of the mobile station is proximate to an object. Responsive to detecting that the mobile station or the antenna is proximate to the object, RF energy being communicated by the mobile station can be distributed among the first antenna and at least a second antenna. Distributing the RF energy can include equally distributing the RF energy among the first antenna, the second antenna and/or any additional antennas. Distributing the RF energy also can include unequally distributing the RF energy among the first antenna, the second antenna and/or any additional antennas. Detecting whether the mobile station or the first antenna is proximate to the object can include detecting a distance between the object and the mobile station or the first antenna.

Distributing the RF energy can include allocating the RF energy to the first antenna and the second antenna based upon the detected distance. In such an arrangement, the method can include detecting a change in the detected distance between the object and the mobile station or the first antenna and, responsive to detecting the change in detected distance, re-allocating the RF energy to the first antenna and the second antenna.

Detecting whether the mobile station or the first antenna is proximate to an object can include detecting proximity of an appendage to the first antenna. Detecting whether the mobile station or the first antenna is proximate to an object also can include measuring at least one parameter corresponding to a loading characteristic of an antenna on the mobile station. Further, detecting whether the mobile station or the first antenna is proximate to an object can include measuring a voltage standing wave ratio (VSWR), a signal to noise ratio (SNR), an amount of reflected energy, a load impedance, an insertion phase delay, a power compression or a gain of a power amplifier.

The present invention also relates to a mobile station that includes at least one sensor that detects whether the mobile station or a first antenna of the mobile station is proximate to an object. The mobile station also can include a power divider that distributes RF energy being communicated by the mobile station among the first antenna and a second antenna in response to detecting that the mobile station or the antenna is proximate to the object. The power divider can equally distribute the RF energy among the first antenna and the second antenna and/or unequally distribute the RF energy among the first antenna and the second antenna. The sensor can detect a distance between the object and the mobile station or the first antenna.

The mobile station further can include a controller. The controller can control the power divider to distribute the RF energy to the first antenna and the second antenna based upon the detected distance. The controller also can receive a signal from the sensor to detect a change in the detected distance between the object and the mobile station or the first antenna. Responsive to detecting the change in detected distance, the controller can control the power divider to re-distribute the RF energy to the first antenna and the second antenna.

The sensor also can detect proximity of an appendage to the first antenna. The sensor also can measure at least one parameter corresponding to a loading characteristic of an antenna on the mobile station. Further, the sensor can measure a voltage standing wave ratio (VSWR), a signal to noise ratio (SNR), an amount of reflected energy, a load impedance, an insertion phase delay, a power compression or a gain of a power amplifier.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a block diagram of mobile station that is useful for understanding the present invention;

FIG. 2 is a schematic diagram of a variable power divider that is useful for understanding the present invention;

FIG. 3 is a flowchart that is useful for understanding the present invention; and

FIG. 4 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a mobile station that detects whether it is proximate to an object that may interfere with the mobile station's RF communications. If so, the mobile station can distribute the energy of its transmit signals among a plurality of antennas. Such distribution can reduce the amount of disruption to the mobile station's communication signals caused by such objects. Accordingly, the mobile station will exhibit superior RF transmission characteristics, thereby reducing the risk of interrupted or dropped calls.

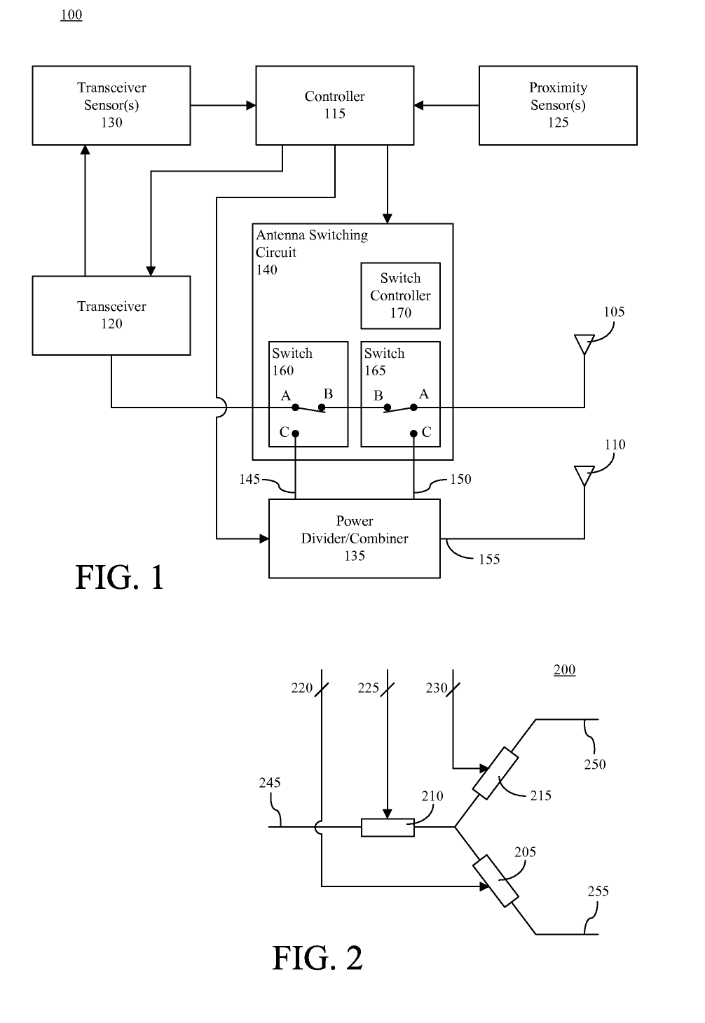

FIG. 1 depicts a block diagram of the mobile station 100 that is useful for understanding the present invention. In one arrangement, the mobile station 100 can be a mobile telephone, a mobile radio or a personal digital assistant. In another arrangement, the mobile station can be a mobile computer or a portable gaming device. The mobile station also can be any other electronic device having a plurality of communication antennas, for example a first antenna 105 and a second 110, and which may transmit RF energy in proximity to an object that may interfere with transmissions from one or more of the antennas 105, 110.

The mobile station 100 can include a controller 115. The controller 115 can comprise, for example, a central processing unit (CPU), a digital signal processor (DSP), an application specific integrated circuit (ASIC), a programmable logic device (PLD), a plurality of discrete components that cooperate to process data, and/or any other suitable processing device.

The mobile station 100 also can include a transceiver 120 that is used by the mobile station 100 to communicate with a communications network or other wireless communication devices. The transceiver 120 can include a transmitter and a receiver and can communicate data via IEEE 802 wireless communications, including 802.11 and 802.16 (WiMax), WPA, WPA2, GSM, TDMA, CDMA, WCDMA, direct wireless communication, TCP/IP, or any other suitable form of wireless communications.

The mobile station 100 can include one or more proximity sensors 125 that detect whether the mobile station 100 or a component of the mobile station 100, such as the first antenna 105, is proximate to an object. As used herein, an object can be an inanimate object or an animate object. An animate object can be, for example, a user or a portion of a user's body, such as an appendage. The proximity sensors 125 can comprise capacitive sensors, thermal sensors, photovoltaic sensors, optical sensors, or any other sensors that can be used to detect presence or proximity of an object. In one arrangement, the proximity sensors 125 can be tuned to detect presence of human tissue. For example, a capacitive sensor can be tuned to detect a capacitance value associated with organic tissue. Similarly, a thermal sensor can be tuned to detect thermal energy associated with organic tissue. Further, an optical sensor can be configured to detect an appendage, such as a hand, finger or ear.

The mobile station 100 also can include one or more transceiver sensors 130 that monitor the transceiver's transmitter, the transceiver's receiver and/or signals communicated between the transceiver 120 and the antennas 105, 110. One example of a transceiver sensor 130 is a sensor that measures a voltage standing wave ratio (VSWR), for instance on a transmission line linking the transceiver 120 to the antennas 105, 110. Another example of a transceiver sensor 130 is a sensor that measures an amount of reflected energy from the antennas 105, 110, a load impedance of the antennas 105, 110 and/or a signal to noise ratio (SNR). Other examples of the transceiver sensors 130 can include sensors that measure an insertion phase delay, a power compression and/or a gain of the transceiver's transmitter (e.g. by monitoring the transmitter's power amplifier). Still, any other sensors can be used that measure parameters that correlate to, or are influenced by, antenna loading characteristics and the invention is not limited in this regard.

Signals generated by the sensors 125, 130 can be processed to determine whether such signals indicate that the mobile station 100 or a component of the mobile station, such as the antenna 105, is located proximate to an object or proximate to a certain type of object, for instance organic tissue. For instance, a signal from a transceiver sensor 130 indicating that the VSWR, SNR and/or signal energy reflection on the transmission line coupling the transceiver 120 to the antenna 105 are higher than threshold values can be indicative of the antenna 105 being held proximate to a certain type of object. A signal from a transceiver sensor 130 indicating that the load impedance of the antenna 105 is not within a particular range also can be indicative of the antenna 105 being held proximate to a certain type of object.

The mobile station 100 also can include a power divider 135 and an antenna switching circuit 140 that selectively connects the antenna 105 to the power divider 135. The power divider 135 can distribute RF energy of transmit signals generated by the transceiver among the antennas 105, 110. Similarly, the power divider 135 can combine the RF energy of receive signals received by the antennas 105, 110 and communicate the receive signals to the transceiver 120.

The power divider 135 can include a plurality of input/output ports 145, 150, 155. Although three ports are shown in the example, the invention is not limited in this regard and the power divider 135 can include any number of ports equal to, or greater than, three. For example, in an arrangement in which the mobile station includes four antennas, the power divider 135 can include five ports; one port for connection to the transceiver 120 and one port for each of the antennas.

Each of the ports 145-155 can present a particular input/output impedance to devices with which the ports are connected. In one arrangement, the power divider 135 can be configured to present the same input/output impedance on each of the ports 145, 150, 155. For example, each of the ports can be configured to present an input/output impedance of 50 ohms or 75 ohms.

The power divider 135 can include any suitable circuit elements. For instance, the power divider 135 can comprise one or more transformer elements, one or more capacitive elements, one or more inductive elements, one or more resistive elements, one or more transmission lines, or a combination of circuit element types. For example, the power divider 135 can comprise a Wilkinson divider which, as known to the skilled artisan, can include both transmission line and resistive elements. Still, the power divider 135 can comprise any other components that can be used to distribute RF energy among two or more antennas 105, 110 and the invention is not limited in this regard.

In one arrangement, the power divider 135 can equally distribute RF energy received via the port 145 among the ports 150, 155. In another arrangement, the RF energy can be unequally distributed among the ports 150, 155. Moreover, the portion of the RF energy that is distributed to each of the ports 150, 155 can be selectively variable. For example, the power divider combiner 135 can receive control signals from the controller 115 that actively configure circuit elements within the power divider 135 in order to control a portion of the RF energy that is delivered via the port 150 and/or the port 155.

The antenna switching circuit 140 can be controlled to communicatively link the power divider 135 to the transceiver 120 and to unlink the power divider 135 from the transceiver 120. The antenna switching circuit 140 can include one or more switches 160, 165. In one arrangement, the switches 160, 165 can be implemented electronically. For example, the switches 160, 165 each can include one or more transistors that, when appropriately biased, provide a communication path between node A and node B of the respective switches 160, 165. Similarly, the switches 160, 165 each can include one or more transistors that, when appropriately biased, provide a communication path between node A and node C of the respective switches 160, 165.

In an arrangement in which the switches are electromechanical, each of the switches 160, 165 can comprise single pole, multi-throw switches. Alternatively, together the switches 160, 165 can be implemented using a double pole, multi-throw configuration. Still, the switches 160, 165 can be implemented in any other suitable manner and the invention is not limited in this regard.

The antenna switching circuit 140 also can include a switch controller 170 that controls operation of the switches 160, 165 in response to one or more control signals received from the controller 115. For example, in an arrangement in which the switches 160, 165 are implemented electronically, the switch controller 170 can bias the appropriate transistors in the switches to establish the desired communication paths. In an arrangement in which the switches 160, 165 are implemented electromechanically, for example using electromagnets that operate mechanical contacts, the switch controller 170 can control the current applied to the electromagnets to control whether the mechanical contacts are opened or closed. The switch controller 170 can control the switches 160, 165 in any other suitable manner and the invention is not limited in this regard. In one arrangement, the controller 170 can be integrated with the controller 115, or the functions of the controller 170 can be performed by the controller 115.

In a first operation mode, the switches 160, 165 can be configured (e.g. via the switch controller 170) to communicatively link the antenna 105 to the transceiver 120 while the power divider 135 is unlinked from the transceiver 120. For example, each of the switches 160, 165 can provide a communication path between its respective node A and node B. In this mode, virtually all of the RF energy generated by the transceiver 120 can be directed to the antenna 105. Similarly, the RF energy received by the transceiver 120 can be limited to the RF energy received by the antenna 105.

In a second operation mode, the switches 160, 165 can be configured to link the power divider 135 to the transceiver 120. Further, in lieu of a direct connection to the transceiver 120, the antenna 105 can be linked to port 150 of the power divider 135. In addition, the antenna 110 can be linked to the port 155 of the power divider 135. To implement this configuration using the present example, each of the switches 160, 165 can provide a communication path between its respective node A and node C. In this mode, virtually all of the RF energy generated by the transceiver 120 can be directed to port 145 of the power divider 135, which can distribute the energy among the antennas 105, 110 via ports 150, 155. Similarly, the RF energy received by the antennas 105, 110 can be directed to the respective ports 150, 155, and the power divider 135 can combine the RF energy prior to communicating the RF energy to the transceiver 120 via port 145.

The controller 115 can select the first operation mode or the second operation mode in any suitable manner. For example, the controller 115 can select the first operation mode when the proximity sensor(s) 125 and/or the transceiver sensor(s) 130 do not indicate that the mobile station 100 and/or the antenna 105 is proximate to organic tissue. If, however, the proximity sensor(s) 125 and/or the transceiver sensor(s) 130 do indicate that the mobile station 100 and/or the antenna 105 is proximate to organic tissue, the controller 115 can select the second operation mode.

In an arrangement in which RF energy generated by the transceiver 120 can be distributed to the antennas 105, 110 unequally, the controller can selectively allocate and un-allocate RF energy to each of the antennas 105, 110. For example, the amount of RF energy applied to the antenna 105 by the power divider 135 can be inversely related to the distance of the antenna 105 to an object. For instance, if the proximity sensor(s) 125 and/or the transceiver sensor(s) 130 indicate that the antenna 105 is a first distance from an object, a relatively large portion of the RF energy can be applied to the antenna 105 while the remaining smaller portion of RF energy is applied to the antenna 110. If the sensors indicate that the antenna 105 has moved to be a second, closer, distance from the object, the RF energy applied to the antenna 105 can be decreased while the RF energy applied to the antenna 110 can be increased. Similarly, if the sensors indicate that the antenna 105 has moved to be a third, farther, distance from the object, the RF energy applied to the antenna 105 can be increased while the RF energy applied to the antenna 110 can be decreased.

FIG. 2 is a schematic diagram of a variable power divider 200 that may be used as the power divider 135 of FIG. 1. The variable power divider 200 can comprise a plurality of variable circuit elements 205, 210, 215. In one arrangement, the variable circuit elements 205, 210, 215 can comprise variable resistors, variable capacitors, variable inductors and/or variable transformers. The variable circuit elements 205, 210, 215 also can comprise circuit traces and/or transmission line segments that can be operatively connected and disconnected from a circuit path.

Signal lines 220, 225, 230 can be provided to the respective variable circuit elements 205, 210, 215 to communicate control signals from the controller that actively configure the variable circuit elements 205, 210, 215. The control signals can, for instance, control transistors comprising the variable circuit elements 205, 210, 215. Such transistors may engage and/or disengage components of the circuit elements 205, 210, 215 in order to change the electrical characteristics of the circuit elements 205, 210, 215, thereby changing energy division/combination ratios. For example, the control signals can change the electrical characteristics of the circuit elements 205, 210, 215 in order to control a portion of the RF energy that is communicated via a port 250 and/or a port 255. Such RF energy can be received via a port 245.

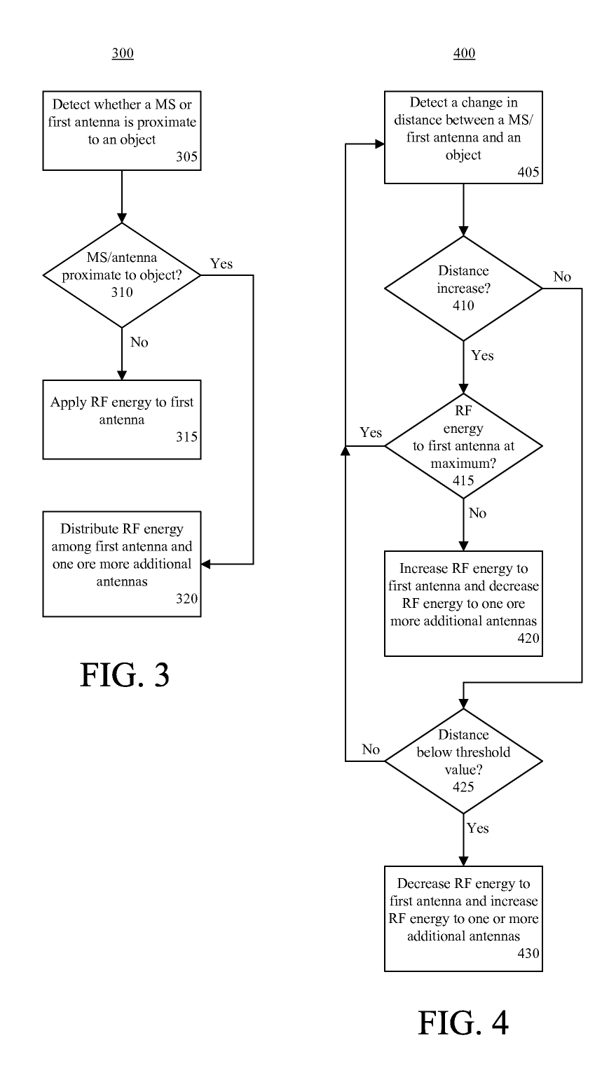

FIG. 3 is a flowchart presenting a method 300 that is useful for understanding the present invention. The method 300 can begin with a mobile station in a state in which the mobile station is transmitting an RF signal or preparing to transmit an RF signal. At step 305, the mobile station can detect whether it or one of its components, for instance a first of its antennas, is proximate to an object. For example, the mobile station can receive data from one or more proximity sensors and/or transmitter sensors that indicate whether the mobile station and/or first antenna is proximate to an object.

Referring to decision box 310, if the mobile station/first antenna is not proximate to the object, at step 315 RF energy can be applied to the first antenna. If, however, the mobile station/first antenna is close to an object, at step 320 RF energy can be distributed among the first antenna and one or more additional antennas. The RF energy can be distributed equally or unequally to the antennas. In one arrangement, the total amount of RF energy can be maintained below a threshold value.

FIG. 4 is another flowchart presenting a method 400 that is useful for understanding the present invention. The method 400 can begin with a mobile station in a state in which the mobile station is transmitting an RF signal. At step 405, the mobile station can detect a change in distance between it, or a first of its antennas, and an object. For example, the mobile station can receive data from one or more proximity sensors and/or transmitter sensors that indicate a change in such proximity.

Referring to decision box 410, if the distance increased, the process can proceed to decision box 415 and a determination can be made whether the RF energy applied to the first antenna is at a maximum value. If the RF energy applied to the first antenna is not at a maximum value, at step 420 the RF energy applied to the first antenna can be increased and RF energy applied to one or more additional antennas can be decreased. If, however, the RF energy is already at maximum, the process can return to step 405 and the mobile station can monitor for a change in distance between the first antenna and other objects.

Referring again to decision box 410, if the distance between the mobile station/first antenna and the object decreases, the process can proceed to decision box 425. If the distance is not below a threshold value, the process can return to step 405. If, however, the distance is below a threshold value, the process can proceed to step 430. At step 430, the RF energy applied to the first antenna can be decreased and the RF energy applied to one or more additional antennas can be increased. As noted, the total amount of RF energy can be maintained below a threshold value.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method for communicating RF signals from a mobile station, comprising:
detecting a distance between an object and the mobile station or a first antenna of the mobile station; and
responsive to detecting the distance between the object and the mobile station or the first antenna of the mobile station, distributing RF energy being communicated by the mobile station among the first antenna and at least a second antenna.

2. The method of claim 1, wherein distributing the RF energy comprises equally distributing the RF energy among the first antenna and the at least second antenna.

3. The method of claim 1, wherein distributing the RF energy comprises unequally distributing the RF energy among the first antenna and the at least second antenna.

4. (canceled)

5. The method of claim 1, wherein distributing the RF energy comprises allocating the RF energy to the first antenna and the at least second antenna based upon the detected distance.

6. The method of claim 1, further comprising:
detecting a change in the detected distance between the object and the mobile station or the first antenna; and
responsive to detecting the change in detected distance, re-distributing the RF energy to the first antenna and the at least second antenna.

7. The method of claim 1, wherein detecting the distance between the object and the mobile station or the first antenna comprises detecting proximity of an appendage to the first antenna.

8. The method of claim 1, wherein detecting the distance between the object and the mobile station or the first antenna comprises measuring at least one parameter corresponding to a loading characteristic of an antenna on the mobile station.

9. The method of claim 1, wherein detecting the distance between the object and the mobile station or the first antenna comprises measuring a voltage standing wave ratio (VSWR), a signal to noise ratio (SNR), an amount of reflected energy or a load impedance.

10. The method of claim 1, wherein detecting the distance between the object and the mobile station or the first antenna comprises measuring an insertion phase delay, a power compression or a gain of a power amplifier.

11. A mobile station, comprising:
at least one sensor that detects a distance between an object and the mobile station or a first antenna of the mobile station; and
a power divider that distributes RF energy being communicated by the mobile station among the first antenna and at least a second antenna in response to detecting the distance between the object and the mobile station or the antenna of the mobile station.

12. The mobile station of claim 11, wherein the power divider equally distributes the RF energy among the first antenna and the at least second antenna.

13. The mobile station of claim 11, wherein the power divider unequally distributes the RF energy among the first antenna and the at least second antenna.

14. (canceled)

15. The mobile station of claim 11, further comprising:
a controller;
wherein the controller controls the power divider to distribute the RF energy to the first antenna and the at least second antenna based upon the detected distance.

16. The mobile station of claim 11, further comprising:
a controller,
wherein the controller receives a signal from the at least one sensor to detect a change in the detected distance between the object and the mobile station or the first antenna and, responsive to detecting the change in detected distance, the controller controls the power divider to re-distribute the RF energy to the first antenna and the at least second antenna.

17. The mobile station of claim 11, wherein the at least one sensor detects proximity of an appendage to the first antenna.

18. The mobile station of claim 11, wherein the at least one sensor measures at least one parameter corresponding to a loading characteristic of an antenna on the mobile station.

19. The mobile station of claim 11, wherein the at least one sensor measures a voltage standing wave ratio (VSWR), a signal to noise ratio (SNR), an amount of reflected energy, a load impedance, an insertion phase delay, a power compression or a gain of a power amplifier.

20. A machine readable storage, having stored thereon a computer program having a plurality of code sections comprising:
code that detects a distance between an object and the mobile station or a first antenna of the mobile station; and
code that distributes RF energy being communicated by the mobile station among the first antenna and at least a second antenna in response to detecting the distance.
